(19) United States
(12) Patent Application Publication
(10) Pub. No.: US 2025/0115185 A1
(43) Pub. Date: Apr. 10, 2025

(54) IMAGE PROCESSING SYSTEM FOR PROVIDING DIGITAL REAR VIEW MONITORING AND IMAGE RECORDING IN VEHICLE, AND ELECTRONIC DEVICES AND OPERATING METHODS OF THE SAME

(71) Applicant: THINKWARE CORPORATION, SEONGNAM-SI (KR)

(72) Inventors: Ho Kwan LEE, SEONGNAM-SI (KR); Hyun Jin BANG, SEONGNAM-SI (KR); Jong Hoon LEE, SEONGNAM-SI (KR); Hyun Chul CHO, SEONGNAM-SI (KR); Sung Rak CHOI, SEONGNAM-SI (KR); Hae Jong CHOI, SEONGNAM-SI (KR)

(21) Appl. No.: 18/906,359

(22) Filed: Oct. 4, 2024

(30) Foreign Application Priority Data
Oct. 6, 2023 (KR) 10-2023-0133005
Nov. 27, 2023 (KR) 10-2023-0166567
Sep. 30, 2024 (KR) 10-2024-0133060

(51) Int. Cl. B60R 1/26; H04N 5/77; H04N 7/18; H04N 23/51; H04N 23/90

(52) U.S. Cl. CPC B60R 1/26; H04N 5/77; H04N 7/181; H04N 23/51; H04N 23/90; B60R 2300/8046

(57) ABSTRACT

The present disclosure provides a video processing system for providing digital rear view monitoring and digital video recording in a vehicle, and electronic devices and operating methods of the same. In the present disclosure, the video processing system is configured to receive and store a front view video and a rear view video of the vehicle, and to display the rear view video on a digital rear mirror module. According to a first example embodiment, the video processing system may be implemented with a first electronic device configured to display the rear view video on the digital rear mirror module, and a second electronic device configured to store the front view video and the rear view video. According to a second example embodiment, the video processing system may be implemented with a single electronic device.

### CROSS-REFERENCE TO RELATED APPLICATION(S)

This application claims the priority benefit under 35 U.S.C. § 119 to Korean Patent Application No. 10-2023-0133005, filed on Oct. 6, 2023, Korean Patent Application No. 10-2023-0166567, filed on Nov. 17, 2023, and Korean Patent Application No. 10-2024-0133060, filed on Sep. 30, 2024, in the Korean Intellectual Property Office, the entire contents of which are incorporated herein by reference in their entirety.

### BACKGROUND

### 1. Field

The present disclosure relates to a video processing system for providing digital rear view monitoring and digital video recording in a vehicle, and electronic devices and operating methods of the same.

### 2. Description of Related Art

A driver that drives a vehicle needs to keep an eye on the rear while looking ahead during driving. To this end, the vehicle is equipped with a rear mirror (which may also be referred to as one of rear view mirror, back mirror, room mirror, and inside mirror). That is, the driver verifies the rear through the rear mirror while maintaining the forward-facing posture. However, due to a separate loading box providing a space for a passenger, an object, or a cargo behind the driver, a rear view of the driver is often blocked. This may lead to various risks.

### SUMMARY

The present disclosure provides a video processing system for providing digital rear view monitoring and digital video recording in a vehicle, and electronic devices and operating methods of the same.

In the present disclosure, a video processing system connected to a front camera module and a rear camera module configured to capture a front view video and a rear view video of a vehicle, respectively, may include a digital rear mirror module configured to display the rear view video in the vehicle, a memory configured to store the front view video and the rear view video, and a processor connected to the digital rear mirror module and the memory, and configured to transmit the front view video and the rear view video from the front camera module and the rear camera module to the memory, and to transmit the rear view video from the rear camera module to the digital rear mirror module.

In the present disclosure, a digital video recording device connected to a front camera module and a rear camera module configured to capture a front view video and a rear view video of a vehicle, respectively, may include a memory and a processor connected to the memory, and the processor may be configured to receive the front view video and the rear view video, to store the front view video and the rear view video in the memory, and to transmit the rear view video to a digital rear mirror device of the vehicle.

In the present disclosure, a digital rear mirror device of a vehicle may include a digital rear mirror module and a processor connected to the digital rear mirror module, and, as a digital video recording device stores and transmits a rear view video of the vehicle from a rear camera module of the vehicle, the processor may be configured to display the rear view video received from the digital video recording device on the digital rear mirror module.

In the present disclosure, an operating method of a video processing system connected to a front camera module and a rear camera module configured to capture a front view video and a rear view video of a vehicle, respectively, may include receiving the front view video and the rear view video of the vehicle, storing the front view video and the rear view video, and displaying the rear view video on a digital rear mirror module.

In the present disclosure, an operating method of a digital video recording device connected to a front camera module and a rear camera module configured to capture a front view video and a rear view video of a vehicle, respectively, may include receiving the front view video and the rear view video, storing the front view video and the rear view video, and transmitting the rear view video to a digital rear mirror device of the vehicle.

In the present disclosure, an operating method of a digital rear mirror device of a vehicle may include, as a digital video recording device stores and transmits a rear view video of the vehicle from a rear camera module of the vehicle, receiving the rear view video from the digital video recording device, and displaying the rear view video on the digital rear mirror module.

According to the present disclosure, a video processing system may provide not only a digital rear view monitoring (DRM) function but also a digital video recording system (DVRS) function. The video processing system may provide an unobstructed rear view to a driver of a vehicle by displaying a rear view video of the vehicle captured by a rear camera module on the digital rear mirror module. In addition, the video processing system may use the rear view video to record at least one of a video while driving the vehicle and a video while parking the vehicle. Therefore, the number of camera devices installed in the vehicle, including a rear camera device, may be reduced. This may lead to a reduction in work hours used to install camera devices in the vehicle, a reduction in installation cost due to the unit cost of camera devices and cables, and a reduction in the weight of the vehicle in which the camera devices are installed.

According to a first example embodiment, a digital rear view monitoring function and a digital video recording system function may be separately implemented in separate electronic devices. Therefore, operating loads of a video processing system may be distributed to the electronic devices. This may prevent degradation in performance of the video processing system in a high temperature environment and may secure stability of the video processing system.

According to a second example embodiment, a digital rear view monitoring function and a digital video recording system function may be integrally implemented in a single electronic device. This may have various advantages in terms of a design of a video processing system, that is, an electronic device. In detail, installation of the video processing system in a vehicle may be easy and the number of parts to implement the electronic device may be reduced. This may lead to a reduction in work hours used to install the video processing system in the vehicle and a reduction in installation cost of the video processing system. In addition, transmission load in the video processing system may be reduced. This may lead to enhancement in transmission noise and increase in transmission power efficiency within the video processing system.

### BRIEF DESCRIPTION OF THE DRAWINGS

FIG. 1 is a block diagram illustrating a configuration of a video processing system according to a first example embodiment.

FIG. 2 is a flowchart illustrating an operating method of a video processing system according to the first example embodiment.

FIG. 3 is a block diagram illustrating an internal configuration of a first electronic device of the video processing system according to the first example embodiment.

FIG. 4 is a flowchart illustrating an operating method of the first electronic device of the video processing system according to the first example embodiment.

FIG. 5 is a block diagram illustrating an internal configuration of a second electronic device of the video processing system according to the first example embodiment.

FIG. 6 is a block diagram illustrating a detailed configuration of an interface module of FIG. 5.

FIG. 7 is a flowchart illustrating an operating method of the second electronic device of the video processing system according to the first example embodiment.

FIG. 8 is a block diagram illustrating a configuration of a video processing system according to a second example embodiment.

FIG. 9 is a block diagram illustrating an internal configuration of an electronic device of the video processing system according to the second example embodiment.

FIG. 10 is a block diagram illustrating a detailed configuration of an interface module of FIG. 9.

FIG. 11 is a flowchart illustrating an operating method of the electronic device of the video processing system according to the second example embodiment.

FIG. 12 is a block diagram illustrating a vehicle to which a video processing system is mounted according to various example embodiments.

FIG. 13 is a block diagram illustrating a control device of the vehicle of FIG. 12.

### DETAILED DESCRIPTION

Hereinafter, various example embodiments of the present document are described with reference to the accompanying drawings.

Initially, a video processing system 100 according to a first example embodiment is described. In the first example embodiment, a digital rear view monitoring function and a digital video recording system function may be separately implemented in separate electronic devices 140 and 150.

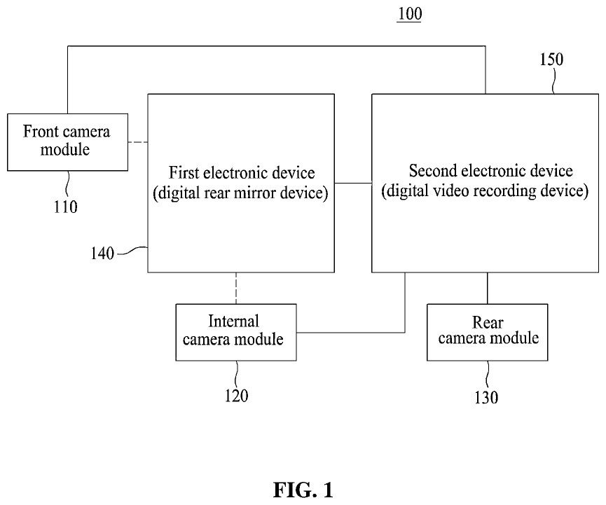

FIG. 1 is a block diagram illustrating a configuration of the video processing system 100 according to the first example embodiment.

Referring to FIG. 1, the video processing system 100 is mounted to a vehicle and may include at least one of a front camera module 110, an internal camera module 120, a rear camera module 130, a first electronic device 140, and a second electronic device 150. In some example embodiments, at least one (e.g., internal camera module 120) among the components of the video processing system 100 may be omitted. In some example embodiments, at least one another component (e.g., side camera modules) may be added. Each of the front camera module 110, the internal camera module 120, and the rear camera module 130 may be communicatively connected to the second electronic device 150, and the first electronic device 140 may be communicatively connected to the second electronic device 150. For example, the electronic device 140 and the electronic device 150 may be connected through vehicle network communication (e.g., controller area network (CAN) communication). The first electronic device 140 and the second electronic device 150 may include various communication chips.

The front camera module 110 may capture a front view video of the vehicle. In an example embodiment, the front camera module 110 may be mounted on the front of the vehicle. For example, the front camera module 110 may be mounted on the windshield inside the vehicle. As another example, the front camera module 110 may be mounted to the first electronic device 140. Further description related thereto is made below. For example, the front camera module 110 may include at least one lens, an image sensor, and an image signal processor (ISP).

The internal camera module 120 may capture an internal video of the vehicle. The internal camera module 120 may be mounted in an upper portion of the vehicle inside the vehicle. For example, the internal camera module 120 may be mounted to the first electronic device 140. Further description related thereto is made below. For example, the internal camera module 120 may include at least one lens, an image sensor, and an image signal processor. In some example embodiments, the internal camera module 120 may be implemented as a 3-channel camera using an optical lens, for example, a fisheye lens, to capture indoors, close-distance front, and close-distance left and right sides.

The rear camera module 130 may capture a rear view video of the vehicle. The rear camera module 130 may be mounted on the rear of the vehicle. For example, the rear camera module 130 may be mounted on the rear surface of the vehicle outside the vehicle. For example, the rear camera module 130 may include at least one lens, an image sensor, and an image signal processor.

The first electronic device 140 may be provided for a digital rear view monitoring function. The first electronic device 140 may also be referred to as a digital rear mirror device. That is, the first electronic device 140 may provide a rear view of the vehicle. The first electronic device 140 may be provided in front of the driver's seat such that the driver of the vehicle may verify the rear view of the vehicle from the driver's seat. The first electronic device 140 may be provided at a location of a typical rear mirror. In detail, the first electronic device 140 may display the rear view video of the vehicle. Here, the first electronic device 140 may have a display area and may display the rear view video of the vehicle as live streaming through the display area.

In various example embodiments, the first electronic device 140 may be accommodated in a housing such that the display area faces the rear of the vehicle. In the first electronic device 140, the display area, that is, the surface that faces the rear of the vehicle may be defined as the front surface of the first electronic device 140. For example, at least one of the front camera module 110 and the internal camera module 120 may be mounted to the first electronic device 140. The front camera module 110 may be mounted on the rear surface of the first electronic device 140. That is, the front camera module 110 may be accommodated in the housing to face the front of the vehicle. The internal camera module 120 may be mounted at the bottom of the first electronic device 140. That is, the internal camera module 120 may be accommodated in the housing to face the inside of the vehicle.

The second electronic device 150 may be provided for the digital video recording system function. The second electronic device 150 may also be referred to as a digital video recording device. That is, the second electronic device 150 may store at least one of a video while driving the vehicle and a video while parking the vehicle. The second electronic device 150 may be provided at any location inside the vehicle. In detail, the second electronic device 150 may receive at least one of the front view video, the internal video, and the rear view video. The second electronic device 150 may store at least one of the front view video, the internal video, and the rear view video. In an example embodiment, the second electronic device 150 may acquire location information, and may store at least one of the front view video, the internal video, and the rear view video with the location information. Meanwhile, the second electronic device 150 may transmit the rear view video to the first electronic device 140 such that the first electronic device 140 may display the rear view video.

In an example embodiment, the front camera module 110, the internal camera module 120, and the rear camera module 130 may transmit the front view video, the internal video, and the rear view video to the second electronic device 150, respectively, using an analog method. The analog method may include, for example, analogue high definition (AHD). In this case, the front camera module 110, the internal camera module 120, and the rear camera module 130 may convert the front view video, the internal video, and the rear view video from digital data to an analog signals and then transmit the same. Meanwhile, the second electronic device 150 may convert the front view video, the internal video, and the rear view video from the analog signal to digital data and then store the same.

In another example embodiment, the front camera module 110, the internal camera module 120, and the rear camera module 130 may transmit the front view video, the internal video, and the rear view video to the second electronic device 150, respectively, using a digital method. For example, the digital method may include a serial transmission method. In this case, each of the front camera module 110, the internal camera module 120, and the rear camera module 130 may include a serializer, and the second electronic device 150 may include a deserializer. The front camera module 110, the internal camera module 120, and the rear camera module 130 may convert the front view video, the internal video, and the rear view video from parallel data to serial data through the respective serializers and then transmit the same. Meanwhile, the second electronic device 150 may convert the front view video, the internal video, and the rear view video from serial data to parallel data through the deserializer and then store the same.

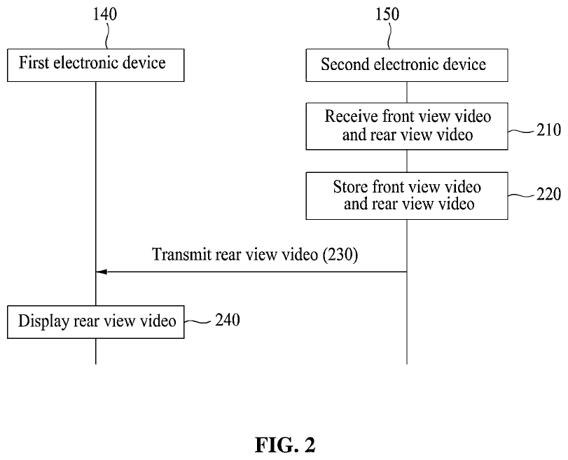

FIG. 2 is a flowchart illustrating an operating method of the video processing system 100 according to the first example embodiment.

Referring to FIG. 2, in operation 210, the second electronic device 150 may receive a front view video and a rear view video of a vehicle. In detail, as the front camera module 110 and the rear camera module 130 capture and transmit the front view video and the rear view video, respectively, the second electronic device 150 may receive the front view video and the rear view video from the front camera module 110 and the rear camera module 130, respectively. Additionally, the second electronic device 150 may further receive an internal video of the vehicle. In detail, as the internal camera module 120 captures and transmits the internal video, the second electronic device 150 may also receive the internal video. In an example embodiment, the second electronic device 150 may acquire location information. Here, the location information may include time information and coordinate information on a current location.

Then, in operation 220, the second electronic device 150 may store the front view video and the rear view video. Here, the second electronic device 150 may store the front view video and the rear view video as is, that is, without adjusting the resolution. In an example embodiment, the second electronic device 150 may store the front view video and the rear view video in correspondence to the location information. Additionally, the second electronic device 150 may store the internal video with the front view video and the rear view video. Here, the second electronic device 150 may store the internal video as is.

Then, in operation 230, the second electronic device 150 may transmit the rear view video to the first electronic device 140. In an example embodiment, the second electronic device 150 may transmit the rear view video as is, that is, without adjusting the resolution. In another example embodiment, the second electronic device 150 may adjust the resolution of the rear view video to the resolution of the display area of the first electronic device 140 and then transmit the rear view video. For example, the second electronic device 150 may detect a portion of the rear view video corresponding to the resolution of the display area of the first electronic device 140 and then, transmit the detected portion. Therefore, the first electronic device 140 may receive the rear view video from the second electronic device 150.

Then, in operation 240, the first electronic device 140 may display the rear view video. In an example embodiment, the first electronic device 140 may adjust the resolution of the rear view video from the second electronic device 150 to the resolution of the display area and then, display the rear view video. For example, when the second electronic device 150 transmits the rear view video as is, that is, without adjusting the resolution, the first electronic device 140 may detect a portion of the rear view video corresponding to the resolution of the display area and then, display the detected portion. Here, the first electronic device 140 may resize the rear view video, for example, the detected portion to a size of the display area. In another example embodiment, the first electronic device 140 may display the rear view video from the second electronic device 150 as is, that is, without adjusting the resolution. For example, when the second electronic device 150 adjusts the resolution of the rear view video to the resolution of the display area of the first electronic device 140, the first electronic device 140 may display the rear view video as is. Here, the first electronic device 140 may resize the rear view video to the size of the display area.

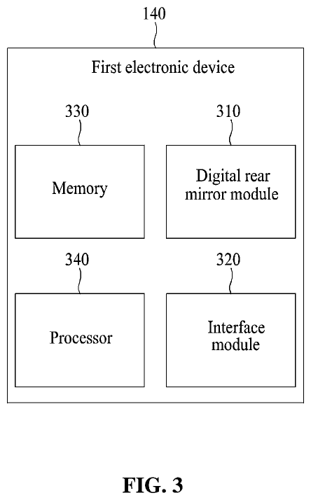

FIG. 3 is a block diagram illustrating an internal configuration of the first electronic device 140 of the video processing system 100 according to the first example embodiment.

Referring to FIG. 3, the first electronic device (digital rear mirror device) 140 may be provided for a digital rear view monitoring function, and may include at least one of a digital rear mirror module 310, an interface module 320, a memory 330, and a processor 340. In some example embodiments, at least one of the components of the first electronic device 140 may be omitted and at least one another component (e.g., input module, sensor module) may be added. In some example embodiments, at least two of the components of the first electronic device 140 may be implemented as a single integrated circuit.

The first electronic device 140 may be mounted to the vehicle with the front camera module 110, the internal camera module 120, the rear camera module 130, and the second electronic device (digital video recording device) 150, and may be communicatively connected to the second electronic device 150. The first electronic device 140 may be provided in front of the driver's seat such that the driver of the vehicle may verify the rear view of the vehicle. The first electronic device 140 may be provided at a location of a typical rear mirror.

In various example embodiments, the first electronic device 140 may be accommodated in a housing such that the digital rear mirror module 310 faces the rear of the vehicle. In the first electronic device 140, a display area of the digital rear mirror module 310, that is, the surface that faces the rear of the vehicle may be defined as the front surface of the first electronic device 140. In an example embodiment, the first electronic device 140 may be mounted to the vehicle separate from the front camera module 110, the internal camera module 120, and the rear camera module 130. In another example embodiment, at least one of the front camera module 110 and the internal camera module 120 may be mounted to the first electronic device 140. The front camera module 110 may be mounted on the rear surface of the first electronic device 140. That is, the front camera module 110 may be accommodated in the housing to face the front of the vehicle. The Internal camera module 120 may be mounted at the bottom of the first electronic device 140. That is, the internal camera module 120 may be accommodated in the housing to face the inside of the vehicle.

The digital rear mirror module 310 may display a video. For example, the digital rear mirror module 310 may include at least one of a display, a hologram device, and a projector. For example, the digital rear mirror module 310 may be implemented as a touchscreen by being assembled with at least one of a touch circuitry and a sensor circuitry of an input module (not shown). In various example embodiments, the digital rear mirror module 310 may have the display area with the predetermined resolution and size.

The interface module 320 may be provided for connection to an external device. In detail, the interface module 320 may support a designated protocol that may be connected to the external device in a wired or wireless manner. Here, the external device may include the second electronic device 150.

The memory 330 may store a variety of data used by at least one component of the first electronic device 140. For example, the memory 330 may include at least one of a volatile memory and a non-volatile memory. Data may include at least one program and input data or output data related thereto. The program may be stored in the memory 330 as software including at least one instruction, and for example, may include at least one of an operating system (OS), middleware, and an application.

The processor 340 may control at least one component of the first electronic device 140 by executing the program of the memory 330. Through this, the processor 340 may perform data processing or operations. Here, the processor 340 may execute instructions stored in the memory 330.

In various example embodiments, the processor 340 may display the rear view video of the vehicle on the digital rear mirror module 310. In detail, the processor 340 may receive the rear view video from the second electronic device 150 through the interface module 320 and may display the rear view video on the digital rear mirror module 310, thereby displaying the rear view video as live streaming. To this end, the processor 340 may process the rear view video based on the resolution and the size of the digital rear mirror module 310. In an example embodiment, when the digital rear mirror module 310 is implemented as a display (e.g., liquid crystal display (LCD)), the processor 340 may include a display controller (e.g., LCD controller). However, without being limited thereto, the processor 340 may display the front view video or the internal video of the vehicle as live streaming on the digital rear mirror module 310. For example, the processor 340 may monitor an environment surrounding the vehicle in real time through live streaming of the front view video. For example, through live streaming of the internal video, the processor 340 may monitor the status of the driver and a passenger in real time and may also monitor an internal status of the vehicle.

Additionally, the processor 340 may detect reference information by analyzing the rear view video and may display the reference information with the rear view video. The reference information may be information within the rear view video, for example, a road sign, and may be information derived from the rear view video, for example, a distance from an adjacent vehicle and a speed of the adjacent vehicle. For example, the processor 340 may display the rear view video and the reference information in the display area of the digital rear mirror module 310. As another example, the digital rear mirror module 310 may further have another display area and the processor 340 may display the reference information in the other display area while displaying the rear view video in the display area of the digital rear mirror module 310. Here, the reference information may be displayed using various graphical representations, for example, text, symbol, and image.

Additionally, the processor 340 may adjust the digital rear mirror module 310 using a sensing input that is input through a sensor module (not shown). For example, the processor 340 may detect the sensing input indicating ambient brightness, which is input through an illuminance sensor. In this case, the processor 340 may change at least one of the brightness and reflectance of the digital rear mirror module 310 using the sensing input.

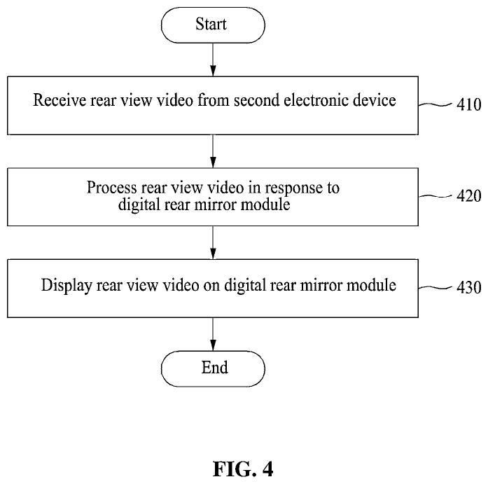

FIG. 4 is a flowchart illustrating an operating method of the first electronic device 140 of the video processing system 100 according to the first example embodiment.

Referring to FIG. 4, in operation 410, the first electronic device 140 may receive a rear view video of the vehicle from the second electronic device 150. In detail, the processor 340 may receive the rear view video from the second electronic device 150 through the interface module 320. Here, as the second electronic device 150 receives the rear view video from the rear camera module 130 and transmits the rear view video to the first electronic device 140, the processor 340 may receive the rear view video. In an example embodiment, the second electronic device 150 may transmit the rear view video as is, that is, without adjusting the resolution. In another example embodiment, the second electronic device 150 may adjust the resolution of the rear view video to the resolution of the display area of the digital rear mirror module 310 and then, transmit the rear view video. For example, the second electronic device 150 may detect a portion of the rear view video corresponding to the resolution of the display area of the digital rear mirror module 310 and then, transmit the detected portion.

Then, in operation 420, the first electronic device 140 may process the rear view video in response to the digital rear mirror module 310. In detail, the processor 340 may adjust the rear view video in correspondence to at least one of the resolution and the size of the display area of the digital rear mirror module 310. In an example embodiment, the processor 340 may process the rear view video in correspondence to the resolution and the size of the display area. In more detail, the processor 340 may adjust the resolution of the rear view video to the resolution of the display area. For example, when the second electronic device 150 transmits the rear view video as is, that is, without adjusting the resolution, the processor 340 may detect a portion of the rear view video corresponding to the resolution of the display area. Then, the processor 340 may resize the rear view video, for example, the detected portion to the size of the display area. In another example embodiment, the processor 340 may process the rear view video in correspondence to the size of the display area. For example, when the second electronic device 150 adjusts the resolution of the rear view video to the resolution of the display area of the first electronic device 140, the processor 340 may not adjust the resolution of the rear view video. Here, the processor 340 may resize the rear view video to the size of the display area.

Then, in operation 430, the first electronic device 140 may display the rear view video on the digital rear mirror module 310. In detail, the processor 340 may display the rear view video in the display area of the digital rear mirror module 310. That is, the rear view video may be displayed according to the resolution and the size of the display area.

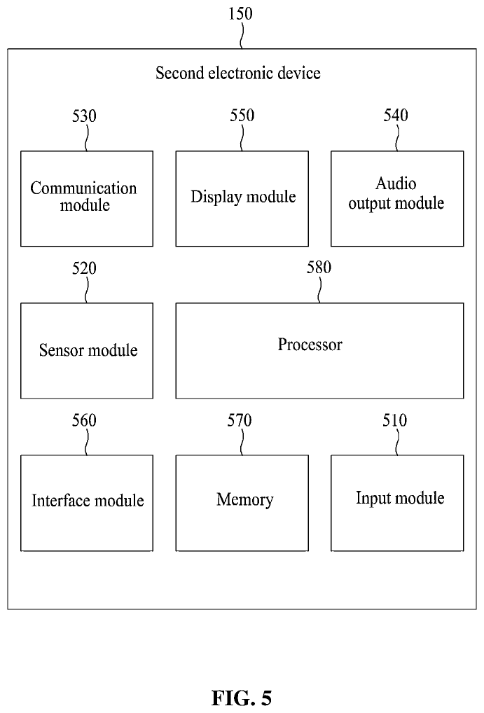

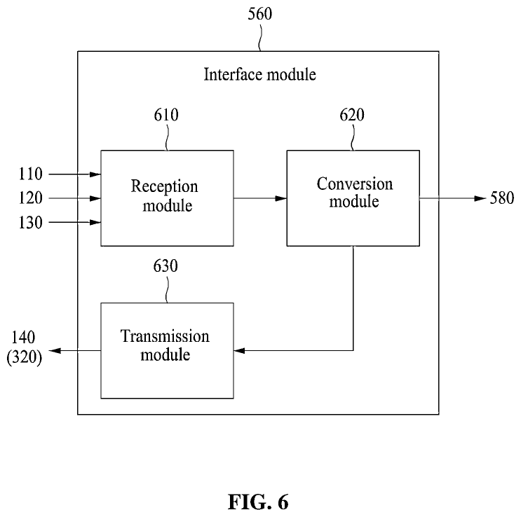

FIG. 5 is a block diagram illustrating an internal configuration of the second electronic device 150 of the video processing system 100 according to the first example embodiment. FIG. 6 is a block diagram illustrating a detailed configuration of the interface module 560 of FIG. 5.

Referring to FIG. 5, the second electronic device (digital video recording device) 150 may be provided for a digital video recording system function, and may include at least one of an input module 510, a sensor module 520, a communication module 530, an audio output module 540, a display module 550, an interface module 560, a memory 570, and a processor 580. In some example embodiments, at least one of components of the second electronic device 150 may be omitted and at least one another component (e.g., auxiliary power module) may be added. In some example embodiments, at least two of the components of the second electronic device 150 may be implemented as a single integrated circuit.

The second electronic device 150 may be mounted to the vehicle with the front camera module 110, the internal camera module 120, the rear camera module 130, and the first electronic device (digital rear mirror device) 140. The second electronic device 150 may be communicatively connected to the front camera module 110, the internal camera module 120, the rear camera module 130, and the first electronic device 140. The second electronic device 150 may be provided at any location inside the vehicle.

The input module 510 may input a signal to be used for at least one component of the second electronic device 150. For example, the input module 510 may include at least one of a key, a button, a keyboard, a keypad, a mouse, a joystick, and a microphone. In some example embodiments, the input module 510 may include at least one of a touch circuitry configured to detect a touch and a sensor circuitry configured to measure strength of force generated by touch.

The sensor module 520 may generate an electrical signal or a data value corresponding to an internal operation state (e.g., power or temperature) of the second electronic device 150 or an external environmental state. For example, the sensor module 520 may include at least one of a global positioning system (GPS) sensor, a radar sensor, a light detection and ranging (LIDAR) sensor, a movement sensor, a gesture sensor, a gyro sensor, a barometric pressure sensor, a magnetic sensor, a motion sensor, an acceleration sensor (e.g., G sensor), a grip sensor, a proximity sensor, a color sensor, an infrared (IR) sensor, a biosignal sensor, a temperature sensor, a humidity sensor, and an illuminance sensor.

The communication module 530 may communicate with an external device. The communication module 530 may establish a communication channel between the second electronic device 150 and the external device and may communicate with the external device through the communication channel. Here, the external device may include at least one of a satellite, a base station, a server, and another electronic device. The communication module 530 may include at least one of a wired communication module and a wireless communication module. The wired communication module may be connected to the external device in a wired manner and may communicate with the external device in the wired manner through a connection terminal. The wireless communication module may include at least one of a near field communication module and a far field communication module. The near field communication module may communicate with the external device using a near field communication scheme. For example, the near field communication scheme may include at least one of Bluetooth, wireless fidelity (WiFi) direct, near field communication (NFC), and infrared data association (IrDA). The far field communication module may communicate with the external device using a far field communication scheme. Here, the far field communication module may communicate with the external device over a network. For example, the network may include at least one of a cellular network, the Internet, and a computer network such as a local area network (LAN) and a wide area network (WAN).

According to various example embodiments, at least one of the input module 510, the sensor module 520, and the communication module 530 may generate a user input. For example, the user input may include at least one of a key (e.g., hard key or soft key) input and a voice input. In an example embodiment, the input module 510 or an arbitrary sensor of the sensor module 520 may generate the user input based on a signal that is directly input from the user. For example, at least one of a movement sensor, a gesture sensor, a proximity sensor, a temperature sensor, and an illuminance sensor may be used for the user input. In another example embodiment, the communication module 530 may generate the user input based on a signal that is input from another electronic device used by the user.

The audio output module 540 may output an audio signal generated from the second electronic device 150. For example, the audio output module 540 may include at least one of a speaker and a receiver. In an example embodiment, the audio output module 540 may include at least one voice coil that provides vibration to a diaphragm within the speaker and a magnet capable of forming a magnetic field. When current flows in the voice coil, the magnetic field formed in the voice coil may vibrate the voice coil through interaction with the magnetic field formed by the magnet. The diaphragm connected to the voice coil may vibrate based on vibration of the voice coil. The speaker may output the audio signal based on the vibration of the diaphragm.

The display module 550 may be provided to display at least one of information and a video. The display module 550 may output visualized information for the driver. For example, the display module 550 may include at least one of a display, a hologram device, and a projector. For example, the display module 550 may be implemented as a touchscreen by being assembled with at least one of a touch circuitry and a sensor circuitry of the input module 510. The display module 550 may be controlled by the processor 580 including a circuit such as a graphic processing unit (GPU) to output visualized information for the user.

The interface module 560 may be provided for connection to an external device. In detail, the interface module 560 may support a designated protocol that may be connected to the external device in a wired or wireless manner. Here, the external device may include at least one of the vehicle, the front camera module 110, the internal camera module 120, the rear camera module 130, and the first electronic device 140.

In detail, as shown in FIG. 6, the interface module 560 may include a reception module 610, a conversion module 620, and a transmission module 630. The reception module 610 may receive at least one of a front view video from the front camera module 110, an internal video from the internal camera module 120, and a rear view video from the rear camera module 130. The conversion module 620 may convert at least one of the front view video, the internal video, and the rear view video. In an example embodiment, when at least one of the front view video, the internal video, and the rear view video is received as an analog signal, the conversion module 620 may convert at least one of the front view video, the internal video, and the rear view video from the analog signal to digital data. In another example embodiment, when at least one of the front view video, the internal video, and the rear view video is received as an analog signal, the conversion module 620 may convert at least one of the front view video, the internal video, and the rear view video from serial data to parallel data. In this case, each of the reception module 610 and the conversion module 620 may be implemented as, for example, a deserializer. The transmission module 630 may transmit the rear view video to the first electronic device 140, particularly, to the interface module 320.

The memory 570 may store a variety of data used by at least one component of the second electronic device 150. For example, the memory 570 may include at least one of a volatile memory and a non-volatile memory. Data may include at least one program and input data or output data related thereto. The program may be stored in the memory 570 as software including at least one instruction, and, for example, may include at least one of an operating system (OS), middleware, and an application. The memory 570 may include at least one of a first memory embedded in the second electronic device 150 and a second memory detachably provided to the second electronic device 150.

The processor 580 may control at least one component of the second electronic device 150 by executing the program of the memory 570. Through this, the processor 580 may perform data processing or operations. Here, the processor 580 may execute instructions stored in the memory 570.

In various example embodiments, the processor 580 may store at least one of a video while driving the vehicle and a video while parking the vehicle in the memory 570. The processor 580 may store the video while driving in the memory 570. The video while driving may be consecutively stored. In addition, the video while driving may be consecutively stored. In addition, the video while driving may be stored with importance when an impact event for the vehicle is detected through the sensor module 520 (e.g., acceleration sensor or G sensor). Here, the processor 580 may store the video while driving in at least one of the first memory and the second memory. For example, the video while driving may be consecutively stored in the first memory and, when the impact event is detected, may be stored in the second memory with the importance. The processor 580 may store the video while parking in the memory 570. For example, when the motion event is detected around the vehicle through the sensor module 520 (e.g., motion sensor or radar sensor), the video while parking may be stored. As another example, when the impact event for the vehicle is detected through the sensor module 520 (e.g., acceleration sensor or G sensor), the video while parking may be stored. Here, the video while parking may be stored with the importance. Here, the processor 580 may store the video while parking in at least one of the first memory and the second memory. For example, when the motion event or the impact event is detected, the video while parking may be stored in the second memory with the importance. In some example embodiments, the processor 580 may have a micro controller unit (MCU), and, while parking the vehicle, the processor 580 may activate only the microcontroller to store the video while parking. Therefore, the second electronic device 150 may operate in a low power mode.

Here, the processor 580 may operate using power of the vehicle. The processor 580 may store the video while driving using the power of the vehicle. In an example embodiment, the processor 580 may use the power of the vehicle to store the video while parking. If a voltage of the vehicle's power exceeds a threshold, the processor 580 may use the power of the vehicle to store the video while parking. Meanwhile, if the voltage of the vehicle's power is less than or equal to the threshold, the processor 580 may not store the video while parking and may also stop storing the video while parking. In another example embodiment, the processor 580 may store the video while parking using the auxiliary power module (e.g., super capacitor) (not shown). For example, when the vehicle's engine is turned off, the processor 580 may store the video while parking using the auxiliary power module. In still another example embodiment, the processor 580 may store the video while parking using external power (e.g., auxiliary battery).

Therefore, the processor 580 may provide the video stored in the memory 570. In an example embodiment, the processor 580 may display the stored video on the display module 550. For example, the processor 580 may display the stored video in response to a user input. In another example embodiment, the processor 580 may transmit the stored video to the external device through the communication module 530. For example, the processor 580 may transmit the stored video in response to the user input. As another example, the processor 580 may transmit the stored video in response to a motion event or an impact event. In still another example embodiment, the processor 580 may provide the stored video to the vehicle through the interface module 560. Therefore, the stored video may be displayed for the user, for example, the driver and an administrator of a server or may be used by the server for the vehicle's safety diagnosis, fault diagnosis, or firmware update.

In detail, the processor 580 may store at least one of the front view video, the internal video, and the rear view video in the memory 570. In an example embodiment, the processor 580 may acquire location information through the communication module 530, and may store at least one of the front view video, the internal video, and the rear view video in the memory 570 with the location information. Here, the location information may include global navigation satellite system (GNSS) information. For example, the GNSS information may include global positioning system (GPS) information.

In various example embodiments, the processor 580 may transmit the rear view video to the first electronic device 140 through the interface module 560, such that the first electronic device 140 may display the rear view video. In some example embodiments, the processor 580 may process the rear view video based on the resolution of the digital rear mirror module 310 and then, transmit the rear view video to the first electronic device 140.

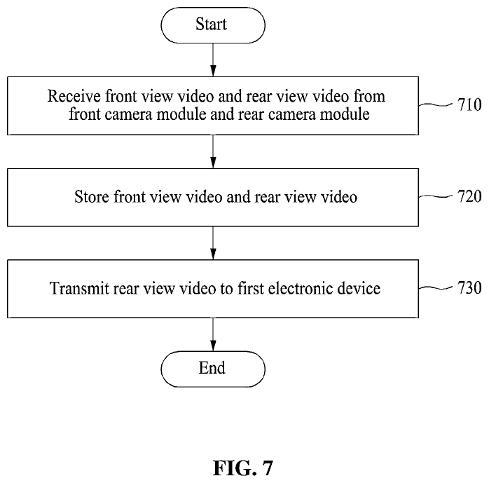

FIG. 7 is a flowchart illustrating an operating method of the second electronic device 150 of the video processing system 100 according to the first example embodiment.

Referring to FIG. 7, in operation 710, the second electronic device 150 may receive a front view video and a rear view video of the vehicle from the front camera module 110 and the rear camera module 130, respectively. In detail, as the front camera module 110 and the rear camera module 130 capture and transmit the front view video and the rear view video, respectively, the processor 580 may receive the front view video and the rear view video from the front camera module 110 and the rear camera module 130, respectively, through the interface module 560. Additionally, the second electronic device 150 may further receive an internal video of the vehicle. In detail, as the internal camera module 120 captures and transmits the internal video, the processor 580 may also receive the internal video. In an example embodiment, the processor 580 may acquire the location information through the communication module 530. Here, the location information may include time information and coordinate information on a current location.

Then, in operation 720, the second electronic device 150 may store the front view video and the rear view video in the memory 570. Here, the processor 580 may store the front view video and the rear view video as is, that is, without adjusting the resolution. In an example embodiment, the processor 580 may store the front view video and the rear view video in correspondence to the location information. Additionally, the second electronic device 150 may store the internal video in the memory 570 with the front view video and the rear view video. Here, the processor 580 may store the internal video as is.

Then, in operation 730, the second electronic device 150 may transmit the rear view video to the first electronic device 140. In an example embodiment, the processor 580 may transmit the rear view video as is, that is, without adjusting the resolution. In another example embodiment, the processor 580 may adjust the resolution of the rear view video to the resolution of the display area of the digital rear mirror module 310 of the first electronic device 140 and then, transmit the rear view video. For example, the processor 580 may detect a portion of the rear view video in correspondence to the resolution of the display area of the digital rear mirror module 310 of the first electronic device 140 and then, transmit the detected portion.

Hereinafter, a video processing system 800 according to a second example embodiment is described. In the second example embodiment, a digital rear view monitoring function and a digital video recording system function may be integrally implemented in a single electronic device 840.

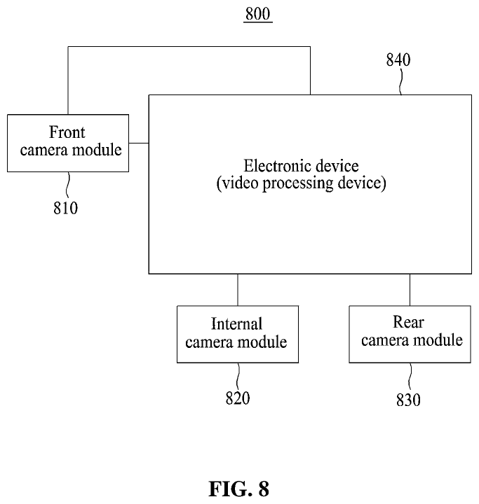

FIG. 8 is a block diagram illustrating a configuration of the video processing system 800 according to the second example embodiment.

Referring to FIG. 8, the video processing system 800 is mounted to a vehicle, and may include at least one of a front camera module 810, an internal camera module 820, a rear camera module 830, and an electronic device 840. In some example embodiments, at least one (e.g., internal camera module 820) of the components of the video processing system 800 may be omitted. In some example embodiments, at least one another component (e.g., side camera modules) may be added. Each of the front camera module 810, the internal camera module 820, and the rear camera module 830 may be communicatively connected to the electronic device 840.

The front camera module 810 may capture a front view video of the vehicle. In an example embodiment, the front camera module 810 may be mounted on the front of the vehicle. For example, the front camera module 810 may be mounted on the windshield inside the vehicle. As another example, the front camera module 810 may be mounted to the electronic device 840. Further description related thereto is made below. For example, the front camera module 810 may include at least one lens, an image sensor, and an image signal processor.

The internal camera module 820 may capture an internal video of the vehicle. The internal camera module 820 may be mounted in an upper portion of the vehicle inside the vehicle. For example, the internal camera module 820 may be mounted to the electronic device 840. Further description related thereto is made below. For example, the internal camera module 820 may include at least one lens, an image sensor, and an image signal processor. In some example embodiments, the internal camera module 820 may be implemented as a 3-channel camera using an optical lens, for example, a fisheye lens, to capture indoors, close-distance front, and close-distance left and right sides.

The rear camera module 830 may capture a rear view video of the vehicle. The rear camera module 830 may be mounted on the rear of the vehicle. For example, the rear camera module 830 may be mounted on the rear surface of the vehicle outside the vehicle. For example, the rear camera module 830 may include at least one lens, an image sensor, and an image signal processor.

The electronic device 840 may be provided for a digital rear view monitoring function and a digital video recording system function. The electronic device 840 may also be referred to as a video processing device. That is, the electronic device 840 may store at least one of a video while driving the vehicle and a video while parking the vehicle, while providing the rear view of the vehicle. The electronic device 840 may be provided in front of the driver's seat such that the driver of the vehicle may verify the rear view of the vehicle from the driver's seat. The electronic device 840 may be provided at a location of a typical rear mirror.

In detail, the electronic device 840 may receive at least one of the front view video, the internal video, and the rear view video. The electronic device 840 may store at least one of the front view video, the internal video, and the rear view video. In an example embodiment, the electronic device 840 may acquire location information, and may store at least one of the front view video, the internal video, and the rear view video with the location information. In addition, the electronic device 840 may display the rear view video of the vehicle. Here, the electronic device 840 may have a display area and may display the rear view video of the vehicle as live streaming through the display area. However, without being limited thereto, the electronic device 840 may display the front view video or the internal video through live streaming.

In various example embodiments, the electronic device 840 may be accommodated in a housing such that the display area faces the rear of the vehicle. In the electronic device 840, the display area, that is, the surface that faces the rear of the vehicle may be defined as the front surface of the electronic device 840. For example, at least one of the front camera module 810 and the internal camera module 820 mounted to the electronic device 840. The front camera module 810 may be mounted on the rear surface of the electronic device 840. That is, the front camera module 810 may be accommodated in the housing to face the front of the vehicle. The internal camera module 820 may be mounted at the bottom of the electronic device 840. That is, the internal camera module 820 may be accommodated in the housing to face the inside of the vehicle.

In an example embodiment, the front camera module 810, the internal camera module 820, and the rear camera module 830 may transmit the front view video, the internal video, and the rear view video to the electronic device 840, respectively, using an analog method. The analog method may include, for example, AHD. In this case, the front camera module 810, the internal camera module 820, and the rear camera module 830 may convert the front view video, the internal video, and the rear view video from digital data to an analog signal and then transmit the same. Meanwhile, the electronic device 840 may convert the front view video, the internal video, and the rear view video from the analog signal to digital data.

In another example embodiment, the front camera module 810, the internal camera module 820, and the rear camera module 830 may transmit the front view video, the internal video, and the rear view video to the electronic device 840, respectively, using a digital method. For example, the digital method may include a serial transmission method. In this case, each of the front camera module 810, the internal camera module 820, and the rear camera module 830 may include a serializer, and the electronic device 840 may include a deserializer. The front camera module 810, the internal camera module 820, and the rear camera module 830 may convert the front view video, the internal video, and the rear view video from parallel data to serial data through the respective serializers and then transmit the same. Meanwhile, the electronic device 840 may convert the front view video, the internal video, and the rear view video from serial data to parallel data through the deserializer and then store the same.

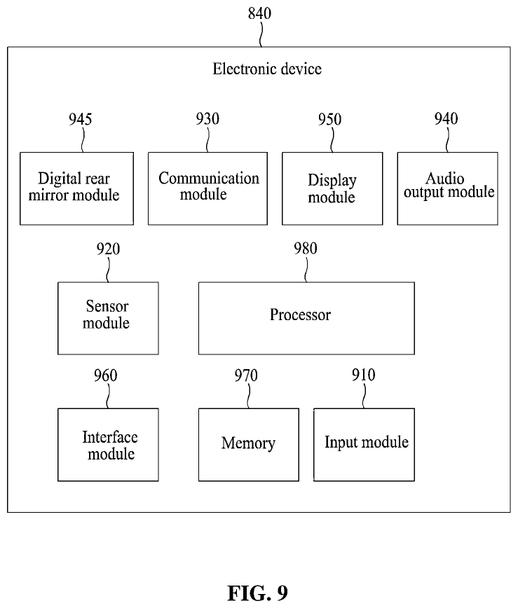

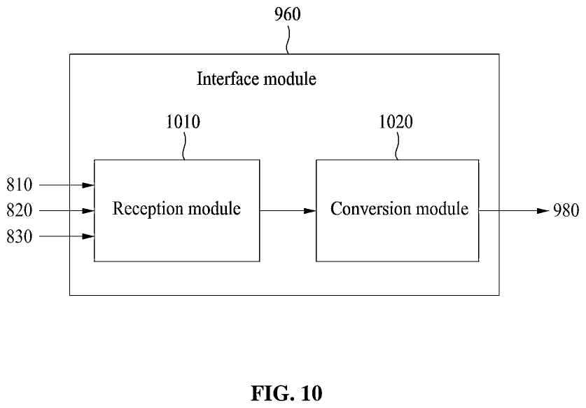

FIG. 9 is a block diagram illustrating an internal configuration of the electronic device 840 of the video processing system 800 according to the second example embodiment. FIG. 10 is a block diagram illustrating a detailed configuration of the interface module 960 of FIG. 9.

Referring to FIG. 9, the electronic device (video processing device) 840 may be provided for a digital rear view monitoring function and a digital video recording system function, and may include at least one of an input module 910, a sensor module 920, a communication module 930, an audio output module 940, a digital rear mirror module 945, a display module 950, an interface module 960, a memory 970, and a processor 980. In some example embodiments, at least one of the components of the electronic device 840 may be omitted and at least one another component (e.g., auxiliary power module) may be added. In some example embodiments, at least two of the components of the electronic device 840 may be implemented as a single integrated circuit.

The electronic device 840 may be mounted to the vehicle with the front camera module 810, the internal camera module 820, and the rear camera module 830. The electronic device 840 may be communicatively connected to the front camera module 810, the internal camera module 820, and the rear camera module 830. The electronic device 840 may be provided in front of the driver's seat such that the driver of the vehicle may verify the rear view of the vehicle. The electronic device 840 may be provided at a location of a typical rear mirror.

In various example embodiments, the electronic device 840 may be accommodated in a housing such that the digital rear mirror module 945 faces the rear of the vehicle. In the electronic device 840, a display area of the digital rear mirror module 945, that is, the surface that faces the rear of the vehicle may be defined as the front surface of the electronic device 840. In an example embodiment, the electronic device 840 may be mounted to the vehicle separate from the front camera module 810, the internal camera module 820, and the rear camera module 830. In another example embodiment, at least one of the front camera module 810 and the internal camera module 820 may be mounted to the electronic device 840. The front camera module 810 may be mounted on the rear surface of the electronic device 840. That is, the front camera module 810 may be accommodated in the housing to face the front of the vehicle. The internal camera module 820 may be mounted at the bottom of the electronic device 840. That is, the internal camera module 820 may be accommodated in the housing to face the inside of the vehicle.

The input module 910 may input a signal to be used for at least one component of the electronic device 840. For example, the input module 910 may include at least one of a key, a button, a keyboard, a keypad, a mouse, a joystick, and a microphone. In some example embodiments, the input module 910 may include at least one of a touch circuitry configured to detect a touch and a sensor circuitry configured to measure strength of force generated by touch.

The sensor module 920 may generate an electrical signal or a data value corresponding to an internal operation state (e.g., power or temperature) of the electronic device 840 or an external environmental state. For example, the sensor module 920 may include at least one of a global positioning system (GPS) sensor, a radar sensor, a LIDAR sensor, a movement sensor, a gesture sensor, a gyro sensor, a barometric pressure sensor, a magnetic sensor, a motion sensor, an acceleration sensor (e.g., G sensor), a grip sensor, a proximity sensor, a color sensor, an IR sensor, a biosignal sensor, a temperature sensor, a humidity sensor, and an illuminance sensor.

The communication module 930 may communicate with an external device. The communication module 930 may establish a communication channel between the electronic device 840 and the external device, and may communicate with the external device through the communication channel. Here, the external device may include at least one of a satellite, a base station, a server, and another electronic device. The communication module 930 may include at least one of a wired communication module and a wireless communication module. The wired communication module may be connected to the external device in a wired manner and may communicate with the external device in the wired manner through a connection terminal. The wireless communication module may include at least one of a near field communication module and a far field communication module. The near field communication module may communicate with the external device using a near field communication scheme. For example, the near field communication scheme may include at least one of Bluetooth, WiFi direct, NFC, and IrDA. The far field communication module may communicate with the external device using a far field communication scheme. Here, the far field communication module may communicate with the external device over a network. For example, the network may include at least one of a cellular network, the Internet, and a computer network such as a LAN and a WAN.

According to various example embodiments, at least one of the input module 910, the sensor module 920, and the communication module 930 may generate a user input. For example, the user input may include at least one of a key (e.g., hard key or soft key) input and a voice input. In an example embodiment, the input module 910 or an arbitrary sensor of the sensor module 920 may generate the user input based on a signal that is directly input from the user. For example, at least one of a movement sensor, a gesture sensor, a proximity sensor, a temperature sensor, and an illuminance sensor may be used for the user input. In another example embodiment, the communication module 930 may generate the user input based on a signal that is input from another electronic device used by the user.

The audio output module 940 may output an audio signal generated from the electronic device 840. For example, the audio output module 940 may include at least one of a speaker and a receiver.

The digital rear mirror module 945 may display a video. For example, the digital rear mirror module 945 may include at least one of a display, a hologram device, and a projector. For example, the digital rear mirror module 945 may be implemented as a touchscreen by being assembled with at least one of a touch circuitry and a sensor circuitry of the input module 910. In various example embodiments, the digital rear mirror module 945 may have a display area with a predetermined resolution and size. Here, in the electronic device 840, the digital rear mirror module 945 may be provided at a location of a typical rear mirror.

The display module 950 may be provided to display at least one of information and a video. For example, the display module 950 may include at least one of a display, a hologram device, and a projector. For example, the display module 950 may be implemented as a touchscreen by being assembled with at least one of a touch circuitry and a sensor circuitry of the input module 910.

The interface module 960 may be provided for connection to an external device. In detail, the interface module 960 may support a designated protocol that may be connected to the external device in a wired or wireless manner. Here, the external device may include at least one of the vehicle, the front camera module 810, the internal camera module 820, and the rear camera module 830.

In detail, as shown in FIG. 10, the interface module 960 may include a reception module 1010 and a conversion module 1020. The reception module 1010 may receive at least one of a front view video from the front camera module 810, an internal video from the internal camera module 820, and a rear view video from the rear camera module 830. The conversion module 1020 may convert at least one of the front view video, the internal video, and the rear view video. In an example embodiment, when at least one of the front view video, the internal video, and the rear view video is received as an analog signal, the conversion module 1020 may convert at least one of the front view video, the internal video, and the rear view video from the analog signal to digital data. In another example embodiment, when at least one of the front view video, the internal video, and the rear view video is received as an analog signal, the conversion module 1020 may convert at least one of the front view video, the internal video, and the rear view video from serial data to parallel data. In this case, each of the reception module 1010 and the conversion module 1020 may be implemented as a deserializer.

The memory 970 may store a variety of data used by at least one component of the electronic device 840. For example, the memory 970 may include at least one of a volatile memory and a non-volatile memory. Data may include at least one program and input data or output data related thereto. The program may be stored in the memory 970 as software including at least one instruction, and for example, may include at least one of an operating system (OS), middleware, and an application. The memory 970 may include at least one of a first memory embedded in the electronic device 840 and a second memory detachably provided to the electronic device 840. For example, to prevent missing and loss and to ensure stability, the second memory may be provided at the top of the electronic device 840. The second memory may be inserted into the housing and may be separated from the housing at the top of the electronic device 840.

The processor 980 may control at least one component of the electronic device 840 by executing the program of the memory 970. Through this, the processor 980 may perform data processing or operations. Here, the processor 980 may execute instructions stored in the memory 970.

In various example embodiments, the processor 980 may store at least one of a video while driving the vehicle and a video while parking the vehicle in the memory 970. The processor 980 may store the video while driving in the memory 970. The video while driving may be consecutively stored. In addition, the video while driving may be stored with importance when an impact event for the vehicle is detected through the sensor module 920 (e.g., acceleration sensor or G sensor). Here, the processor 980 may store the video while driving in at least one of the first memory and the second memory. For example, the video while driving may be consecutively stored in the first memory and, when the impact event is detected, may be stored in the second memory with the importance. The processor 980 may store the video while parking in the memory 970. For example, when the motion event is detected around the vehicle through the sensor module 920 (e.g., motion sensor or radar sensor), the video while parking may be stored. As another example, when the impact event for the vehicle is detected through the sensor module 920 (e.g., acceleration sensor or G sensor), the video while parking may be stored. Here, the processor 980 may store the video while parking in at least one of the first memory and the second memory. For example, when the motion event or the impact event is detected, the video while parking may be stored in the second memory with the importance. In some example embodiments, the processor 980 may have a micro controller unit (MCU), and while parking the vehicle, the processor 980 may activate only the microcontroller to store the video while parking. Therefore, the electronic device 840 may operate in a low power mode.

Here, the processor 980 may operate using power of the vehicle. The processor 980 may store the video while driving using the power of the vehicle. In an example embodiment, the processor 980 may use the power of the vehicle to store the video while parking. If a voltage of the vehicle's power exceeds a threshold, the processor 980 may use the power of the vehicle to store the video while parking. Meanwhile, if the voltage of the vehicle's power is less than or equal to the threshold, the processor 980 may not store the video while parking and may also stop storing the video while parking. In another example embodiment, the processor 980 may store the video while parking using the auxiliary power module (e.g., super capacitor) (not shown). For example, when the vehicle's engine is turned off, the processor 980 may store the video while parking using the auxiliary power module. In still another example embodiment, the processor 980 may store the video while parking using external power (e.g., auxiliary battery).

Therefore, the processor 980 may provide the video stored in the memory 970. In an example embodiment, the processor 980 may display the stored video on the display module 950. For example, the processor 980 may display the stored video in response to a user input. In another example embodiment, the processor 980 may transmit the stored video to the external device through the communication module 930. For example, the processor 980 may transmit the stored video in response to the user input. As another example, the processor 980 may transmit the stored video in response to a motion event or an impact event. In still another example embodiment, the processor 980 may provide the stored video to the vehicle through the interface module 960. Therefore, the stored video may be displayed for the user, for example, the driver and an administrator of a server or may be used by the server for the vehicle's safety diagnosis, fault diagnosis, or firmware update.

In detail, the processor 980 may store at least one of the front view video, the internal video, and the rear view video in the memory 970. In an example embodiment, the processor 980 may acquire location information through the communication module 930, and may store at least one of the front view video, the internal video, and the rear view video in the memory 970 with the location information. Here, the location information may include GNSS information. For example, the GNSS information may include GPS information.

In various example embodiments, the processor 980 may display the rear view video of the vehicle on the digital rear mirror module 945. In detail, the processor 980 may display the rear view video as live streaming by receiving the rear view video from the rear camera module 830 through the interface module 960 and by displaying the rear view video on the digital rear mirror module 945. To this end, the processor 980 may process the rear view video based on the resolution and the size of the digital rear mirror module 945. In an example embodiment, when the digital rear mirror module 945 is implemented as a display (e.g., LCD), the processor 980 may include a display controller (e.g., LCD controller).

Additionally, the processor 980 may detect reference information by analyzing the rear view video and may display the reference information with the rear view video. The reference information may be information within the rear view video, for example, a road sign, and may be information derived from the rear view video, for example, a distance from an adjacent vehicle and a speed of the adjacent vehicle. For example, the processor 980 may display the rear view video and the reference information in the display area of the digital rear mirror module 945. As another example, the processor 980 may display the reference information on the display module 950 while displaying the rear view video in the display area of the digital rear mirror module 945. Here, the reference information may be displayed using various graphical representations, for example, text, symbol, and image.

Additionally, the processor 980 may adjust the digital rear mirror module 945 using a sensing input that is input through the sensor module 920. For example, the processor 980 may detect the sensing input indicating ambient brightness, which is input through an illuminance sensor. In this case, the processor 980 may change at least one of the brightness and reflectance of the digital rear mirror module 945 using the sensing input.

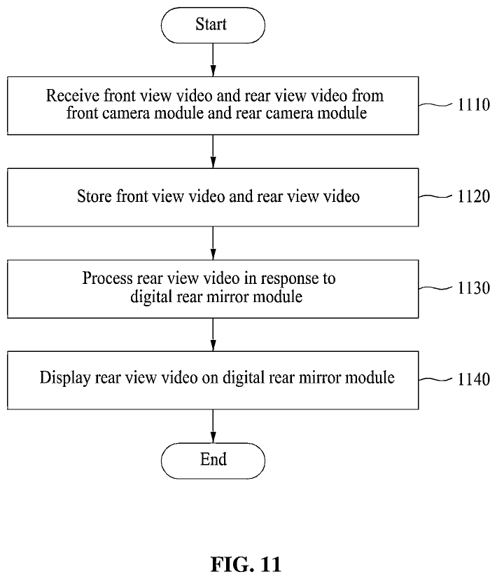

FIG. 11 is a flowchart illustrating an operating method of the electronic device 840 of the video processing system 800 according to the second example embodiment.

Referring to FIG. 11, in operation 1110, the electronic device 840 may receive a front view video and a rear view video of a vehicle from the front camera module 810 and the rear camera module 830, respectively. In detail, as the front camera module 810 and the rear camera module 830 capture and transmit the front view video and the rear view video, respectively, the processor 980 may receive the front view video and the rear view video from the front camera module 810 and the rear camera module 830, respectively, through the interface module 960. Additionally, the electronic device 840 may further receive an internal video of the vehicle. In detail, as the internal camera module 820 captures and transmits the internal video, the processor 980 may also receive the internal video. In an example embodiment, the processor 980 may acquire location information through the communication module 930. Here, the location information may include time information and coordinate information on a current location.

Then, in operation 1120, the electronic device 840 may store the front view video and the rear view video in the memory 970. Here, the processor 980 may store the front view video and the rear view video as is, that is, without adjusting the resolution. In an example embodiment, the processor 980 may store the front view video and the rear view video in correspondence to the location information. Additionally, the electronic device 840 may store the internal video in the memory 970 with the front view video and the rear view video. Here, the processor 980 may store the internal video as is.

Then, in operation 1130, the electronic device 840 may process the rear view video in response to the digital rear mirror module 945. In detail, the processor 980 may process the rear view video in correspondence to at least one of the resolution and the size of the display area of the digital rear mirror module 945. In an example embodiment, the processor 980 may process the rear view video in correspondence to the resolution and the size of the display area. In more detail, the processor 980 may adjust the resolution of the rear view video to the resolution of the display area. For example, the processor 980 may detect a portion of the rear view video in correspondence to the resolution of the display area. Then, the processor 980 may resize the rear view video, for example, the detected portion to the size of the display area.

Then, in operation 1140, the electronic device 840 may display the rear view video on the digital rear mirror module 945. In detail, the processor 980 may display the rear view video in the display area of the digital rear mirror module 945. That is, the rear view video may be displayed according to the resolution and the size of the display area.

According to the present disclosure, the video processing system 100, 800 may provide not only a digital rear view monitoring function but also a digital video recording system function. The video processing system 100, 800 may provide an unobstructed rear view of the vehicle to the driver of the vehicle by displaying the rear view video of the vehicle captured by the rear camera module 130, 830 on the digital rear mirror module 310, 945. In addition, the video processing system 100, 800 may use the corresponding rear view video to record at least one of a video while driving the vehicle and a video while parking the vehicle. Therefore, the number of camera devices installed in the vehicle, including the rear camera device 130, 830, may be reduced. This may lead to a reduction in work hours used to install camera devices in the vehicle, a reduction in installation cost due to the unit cost of camera devices and cables, and a reduction in the weight of the vehicle in which the camera devices are installed.

According to the first example embodiment, the digital rear view monitoring function and the digital video recording system function may be separately implemented in separate electronic devices 140 and 150. Therefore, operating loads of the video processing system 100 may be distributed to the electronic devices 140 and 150. This may prevent degradation in performance of the video processing system 100 in a high temperature environment and may secure stability of the video processing system 100.

According to the second example embodiment, the digital rear view monitoring function and the digital video recording system function may be integrally implemented in a single electronic device 840. This may have various advantages in terms of a design of the video processing system 800, that is, the electronic device 840. In detail, installation of the video processing system 800 in the vehicle may be easy and the number of parts to implement the electronic device 840 may be reduced. This may lead to a reduction in work hours used to install the video processing system 800 in the vehicle and a reduction in installation cost of the video processing system 800. In addition, transmission load in the video processing system 800 may be reduced. This may lead to enhancement in transmission noise and increase in transmission power efficiency within the video processing system 800.

In short, the present disclosure provides the video processing system 100, 800 for providing digital rear view monitoring and digital video recording in the vehicle and the electronic devices 140, 150, and 840 and operating methods of the same.

In the present disclosure, the video processing system 100, 800 may be connected to the front camera module 110, 810 and the rear camera module 130, 830 configured to capture a front view video and a rear view video of the vehicle, respectively, and may include the digital rear mirror module 310, 945 configured to display the rear view video in the vehicle, the memory 570, 970 to store the front view video and the rear view video, and the processor 580, 980 connected to the digital rear mirror module 310, 945 and the memory 570, 970, and configured to transmit the front view video and the rear view video from the front camera module 110, 810 and the rear camera module 130, 830 to the memory 570, 970, and to transmit the rear view video from the rear camera module 130, 830 to the digital rear mirror module 310, 945.

According to the first example embodiment, the video processing system 100 may be implemented with the first electronic device 140 mounted at a predetermined location in the vehicle and including the digital rear mirror module 310, and the second electronic device 150 provided separate from the first electronic device 140 and including the memory 570 and the processor 580.

In the first example embodiment, the first electronic device 140 may be accommodated in a housing such that the digital rear mirror module 310 faces the rear of the vehicle, and the front camera module 110 may be mounted to the first electronic device 140 to face the front of the vehicle.

In the first example embodiment, the video processing system 100 may be connected to the internal camera module 120 configured to capture an internal video of the vehicle, and the processor 580 may be connected to the internal camera module 120, and configured to transmit the internal video to the memory 570 such that the memory 570 stores the internal video.

In the first example embodiment, the first electronic device 140 may be accommodated in a housing such that the digital rear mirror module 310 faces the rear of the vehicle, and the internal camera module 120 may be mounted to the first electronic device 140 to face the inside of the vehicle.

In the first example embodiment, the video processing system 100 may further include the interface module 560 connected between the front camera module 110 and the rear camera module 130 and the processor 580, and configured to transmit the front view video and the rear view video from the front camera module 110 and the rear camera module 130 to the processor 580, and the second electronic device 150 may include the interface module 560 with the memory 570 and the processor 580.

According to the second example embodiment, the video processing system 800 may be implemented with a single electronic device 840 mounted at a predetermined location in the vehicle.

In the second example embodiment, the electronic device 840 may be accommodated in a housing such that the digital rear mirror module 945 faces the rear of the vehicle, and the front camera module 810 may be mounted to the electronic device 840 to face the front of the vehicle.

In the second example embodiment, the video processing system 800 may be connected to the internal camera module 820 configured to capture an internal video of the vehicle, and the processor 980 may be connected to the internal camera module 820, and configured to transmit the internal video to the memory 970, such that the memory 970 stores the internal video.

In the second example embodiment, the electronic device 840 may be accommodated in a housing such that the digital rear mirror module 945 faces the rear of the vehicle, and the internal camera module 820 may be mounted to the electronic device 840 to face the inside of the vehicle.

According to an example embodiment, the digital video recording device 150 may be connected to the front camera module 110 and the rear camera module 130 configured to capture the front view video and the rear view video of the vehicle, respectively, and may include the memory 570 and the processor 580 connected to the memory 570, and the processor 580 may be configured to receive the front view video and the rear view video, to store the front view video and the rear view video in the memory 570, and to transmit the rear view video to the digital rear mirror device 140 of the vehicle.

According to an example embodiment, the digital rear mirror device 140 of the vehicle may include the digital rear mirror module 310 and the processor 340 connected to the digital rear mirror module 310, and as the digital video recording device 150 stores and transmits the rear view video of the vehicle from the rear camera module 130 of the vehicle, the processor 340 may be configured to display the rear view video received from the digital video recording device 150 on the digital rear mirror module 310.

In an example embodiment, the digital rear mirror module 310 may be accommodated in a housing to face the rear of the vehicle.

In an example embodiment, the digital rear mirror device 140 may further include at least one of the front camera module 110 configured to capture the front view video of the vehicle and accommodated in the housing to face the front of the vehicle, and the internal camera module 120 configured to capture the internal video of the vehicle and accommodated in the housing to face the inside of the vehicle.

In the present disclosure, the video processing system 100, 800 may be connected to the front camera module 110, 810 and the rear camera module 130, 830 configured to capture the front view video and the rear view video of the vehicle, respectively, and an operating method of the video processing system 100, 800 may include receiving the front view video and the rear view video of the vehicle (operation 210, operation 1110), storing the front view video and the rear view video (operation 220, operation 1120), and displaying the rear view video on the digital rear mirror module 310, 945 (operation 240, operation 1140).

According to the first example embodiment, the video processing system 100 may be separately implemented with the first electronic device 140 mounted at a predetermined location in the vehicle and including the digital rear mirror module 310, and the second electronic device 150 provided separate from the first electronic device 140.

In the first example embodiment, the receiving the front view video and the rear view video (operation 210), and the storing the front view video and the rear view video (operation 220) may be performed by the second electronic device 150, and the displaying the rear view video on the digital rear mirror module 310 (operation 240) may be performed by the first electronic device 140.

In the first example embodiment, the operating method of the video processing system 100 may further include transmitting, by the second electronic device 150, the rear view video to the first electronic device 140 (operation 230).

In the first example embodiment, the first electronic device 140 may be accommodated in a housing such that the digital rear mirror module 310 faces the rear of the vehicle, and the front camera module 110 may be mounted to the first electronic device 140 to face the front of the vehicle.

In the first example embodiment, the video processing system 100 may be connected to the internal camera module 120 configured to capture the internal video of the vehicle, and the receiving the front view video and the rear view video (operation 210) may include receiving the internal video with the front view video and the rear view video, and the storing the front view video and the rear view video (operation 220) may include storing the internal video with the front view video and rear view video.

In the first example embodiment, the first electronic device 140 may be accommodated in a housing such that the digital rear mirror module 310 faces the rear of the vehicle, and the internal camera module 120 may be mounted to the first electronic device 140 to face the inside of the vehicle.

According to the second example embodiment, the video processing system 800 may be implemented with a single electronic device 840 mounted at a predetermined location in the vehicle.

In the second example embodiment, the electronic device 840 may be accommodated in a housing such that the digital rear mirror module 945 faces the rear of the vehicle, and the front camera module 810 may be mounted to the electronic device 840 to face the front of the vehicle.

In the second example embodiment, the video processing system 800 may be connected to the internal camera module 820 configured to capture an internal video of the vehicle, and the receiving the front view video and the rear view video (operation 1110) may include receiving the internal video with the front view video and the rear view video, and the storing the front view video and the rear view video (operation 1120) may include storing the internal video with the front view video and the rear view video.

In the second example embodiment, the electronic device 840 may be accommodated in a housing such that the digital rear mirror module 945 faces the rear of the vehicle, and the internal camera module 820 may be mounted to the electronic device 840 to face the inside of the vehicle.

According to an example embodiment, the digital video recording device 150 may be connected to the front camera module 110 and the rear camera module 130 configured to capture the front view video and the rear view video of the vehicle, respectively, and an operating method of the digital video recording device 150 may include receiving the front view video and the rear view video (operation 710), storing the front view video and the rear view video (operation 720), and transmitting the rear view video to the digital rear mirror device 140 of the vehicle (operation 730).

According to an example embodiment, an operating method of the digital rear mirror device 140 of the vehicle may include, as the digital video recording device 150 stores and transmits the rear view video of the vehicle from the rear camera module 130 of the vehicle, receiving the rear view video from the digital video recording device 150 (operation 410), and displaying the rear view video on the digital rear mirror module 310 (operation 430).

In an example embodiment, the digital rear mirror device 140 may be accommodated in a housing such that the digital rear mirror module 310 faces the rear of the vehicle.

In an example embodiment, the digital rear mirror device 140 may include at least one of the front camera module 110 configured to capture the front view video of the vehicle and accommodated in the housing to face the front of the vehicle, and the internal camera module 120 configured to capture the internal video of the vehicle and accommodated in the housing to face the inside of the vehicle.

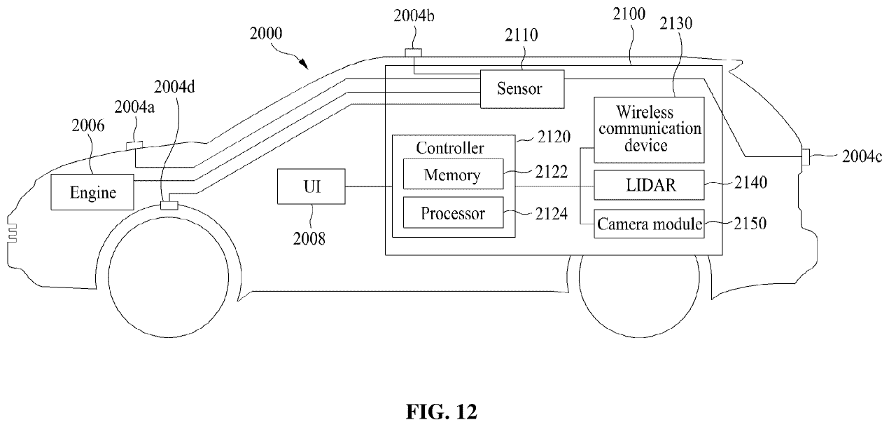

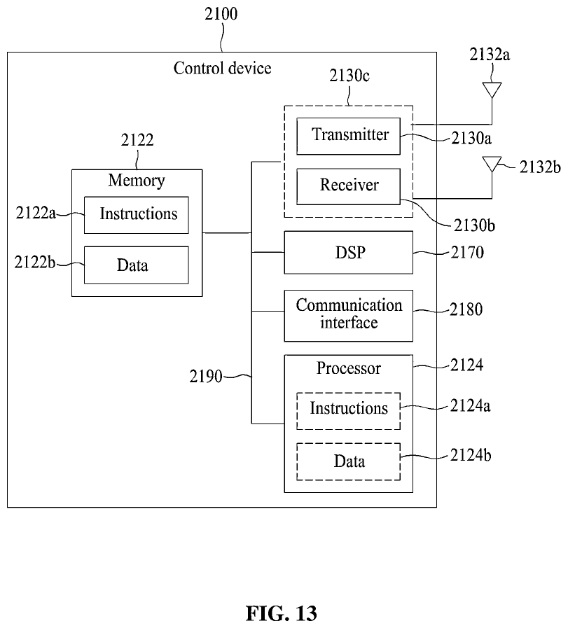

FIG. 12 is a block diagram illustrating a vehicle 2000 to which the video processing system 100, 800 is mounted according to various example embodiments. FIG. 13 is a block diagram illustrating a control device 2100 of the vehicle of FIG. 12.

Referring to FIGS. 12 and 13, the video processing system 100, 800 according to various example embodiments may be mounted to the vehicle 2000 and the vehicle 2000 may include the control device 2100. Here, the vehicle 2000 may be an autonomous vehicle. In some example embodiments, at least one component of the electronic device 100 may be integrated into at least one component of the video processing system 100, 800.

The control device 2100 may include a controller 2120 that includes a memory 2122 and a processor 2124, a sensor 2110, a wireless communication device 2130, a LiDAR device 2140, and a camera module 2150.

The controller 2120 may be configured at a time of manufacture by a manufacturing company of the vehicle or may be additionally configured to perform an autonomous driving function after manufacture. Alternatively, a configuration to continuously perform an additional function by upgrading the controller 2120 configured at the time of manufacture may be included.

The controller 2120 may forward a control signal to the sensor 2110, an engine 2006, a user interface (UI) 2008, the wireless communication device 2130, the LIDAR device 2140, and the camera module 2150 included as other components in the vehicle. Also, although not illustrated, the controller 2120 may forward a control signal to an acceleration device, a braking system, a steering device, or a navigation device associated with driving of the vehicle.

The controller 2120 may control the engine 2006. For example, the controller 2120 may sense a speed limit of a road on which the vehicle 2000 is driving and may control the engine 2006 such that a driving speed may not exceed the speed limit, or may control the engine 2006 to increase the driving speed of the vehicle 2000 within the range of not exceeding the speed limit. Additionally, when sensing modules 2004a, 2004b, 2004c, and 2004d sense an external environment of the vehicle and forward the same to the sensor 2110, the controller 2120 may receive external environment information, may generate a signal for controlling the engine 2006 or a steering device (not shown), and thereby control driving of the vehicle.

When another vehicle or an obstacle is present in front of the vehicle, the controller 2120 may control the engine 2006 or the braking system to decrease the driving speed and may also control a trajectory, a driving route, and a steering angle in addition to the speed. Alternatively, the controller 2120 may generate a necessary control signal according to recognition information of other external environments, such as, for example, a driving lane, a driving signal, etc., of the vehicle, and may control driving of the vehicle.

The controller 2120 may also control driving of the vehicle by communicating with a nearby vehicle or a central server in addition to autonomously generating the control signal and by transmitting an instruction for controlling peripheral devices based on the received information.

Further, if a location or an angle of view of the camera module 2150 is changed, it may be difficult for the controller 2120 to accurately recognize a vehicle or a lane. To prevent this, the controller 2120 may generate a control signal for controlling a calibration of the camera module 2150. Therefore, the controller 2120 may generate a calibration control signal for the camera module 2150 and may continuously maintain a normal mounting location, direction, angle of view, etc., of the camera module 2150 regardless of a change in a mounting location of the camera module 2150 by a vibration or an impact occurring due to a motion of the autonomous vehicle 2000. When prestored information on an initial mounting location, direction, and angle of view of the camera module 2120 differs from information on the initial mounting location, direction, and angle of view of the camera module 2120 that are measured during driving of the autonomous vehicle 2000 by a threshold or more, the controller 2120 may generate a control signal for performing calibration of the camera module 2120.

The controller 2120 may include the memory 2122 and the processor 2124. The processor 2124 may execute software stored in the memory 2122 in response to the control signal of the controller 2120. In detail, the controller 2120 may store, in the memory 2122, data and instructions for detecting a visual field view from a rear view video of the vehicle 2000, and the instructions may be executed by the processor 2124 to perform one or more methods disclosed herein.

Here, the memory 2122 may be stored in a recording medium executable at the non-volatile processor 2124. The memory 2122 may store software and data through an appropriate external device. The memory 2122 may include random access memory (RAM), read only memory (ROM), hard disk, and a memory device connected to a dongle.

The memory 2122 may at least store an operating system (OS), a user application, and executable instructions. The memory 2122 may store application data and arrangement data structures.

The processor 2124 may be a controller, a microcontroller, or a state machine as a microprocessor or an appropriate electronic processor.

The processor 2124 may be configured as a combination of computing devices. The computing device may be configured as a digital signal processor, a microprocessor, or an appropriate combination thereof.

Also, the control device 2100 may monitor internal and external features of the vehicle 2000 and may detect a state of the vehicle 2000 using at least one sensor 2110.

The sensor 2110 may include at least one sensing module 2004. The sensing module 2004 may be implemented at a specific location of the vehicle 2000 depending on a sensing purpose. The sensing module 2004 may be provided in a lower portion, a rear end, a front end, an upper end, or a side end of the vehicle 2000 and may be provided to an internal part of the vehicle, a tier, and the like.

Through this, the sensing module 2004 may sense driving information, such as the engine 2006, a tier, a steering angle, a speed, a vehicle weight, and the like, as internal vehicle information. Also, the at least one sensing module 2004 may include an acceleration sensor (2110), a gyroscope, an image sensor (2110), a radar, an ultrasound sensor, a LiDAR sensor, and the like, and may sense motion information of the vehicle 2000.

The sensing module 2004 may receive specific data, such as state information of a road on which the vehicle 2000 is present, nearby vehicle information, and an external environmental state such as weather, as external information, and may sense a vehicle parameter according thereto. The sensed information may be stored in the memory 2122 temporarily or in long-term depending on purposes.

The sensor 2110 may integrate and collect information of the sensing modules 2004 for collecting information generated inside and on outside the vehicle 2000.

The control device 2100 may further include the wireless communication device 2130.

The wireless communication device 2130 is configured to implement wireless communication between the vehicles 2000. For example, the wireless communication device 2130 enables the vehicles 2000 to communicate with a mobile phone of a user, another wireless communication device 2130, another vehicle, a central device (traffic control device), a server, and the like. The wireless communication device 2130 may transmit and receive a wireless signal according to a connection communication protocol. A wireless communication protocol may be WiFi, Bluetooth, Long-Term Evolution (LTE), code division multiple access (CDMA), wideband code division multiple access (WCDMA), and global systems for mobile communications (GSM). However, it is provided as an example only and the wireless communication protocol is not limited thereto.

Also, the vehicle 2000 may implement vehicle-to-vehicle (V2V) communication through the wireless communication device 2130. That is, the wireless communication device 2130 may perform communication with another vehicle and other vehicles on the roads through the V2V communication. The vehicle 2000 may transmit and receive information, such as driving warnings and traffic information, through the V2V communication and may also request another vehicle for information or may receive a request from the other vehicle. For example, the wireless communication device 2130 may perform the V2V communication using a dedicated short-range communication (DSRC) device or a cellular-V2V (CV2V) device. Also, in addition to the V2V communication, vehicle-to-everything (V2X) communication, communication between the vehicle and another object (e.g., electronic device carried by pedestrian), may be implemented through the wireless communication device 2130.

Also, the control device 2100 may include the LIDAR device 2140. The LIDAR device 2140 may detect an object around the vehicle 2000 during an operation, based on data sensed using a LIDAR sensor. The LIDAR device 2140 may transmit detection information to the controller 2120, and the controller 2120 may operate the vehicle 2000 based on the detection information. For example, when the detection information includes a vehicle ahead driving at a low speed, the controller 2120 may instruct the vehicle to decrease a speed through the engine 2006. Alternatively, the controller 2120 may instruct the vehicle to decrease a speed based on a curvature of a curve the vehicle enters.

The control device 2100 may further include the camera module 2150. The controller 2120 may extract object information from an external image captured from the camera module 2150, and may process the extracted object information using the controller 2120.

Also, the control device 2100 may further include imaging devices configured to recognize an external environment. In addition to the LIDAR device 2140, a radar, a GPS device, a driving distance measurement device (odometry), and other computer vision devices may be used. Such devices may selectively or simultaneously operate depending on necessity, thereby enabling further precise sensing.

The vehicle 2000 may further include the user interface (UI) 2008 for a user input to the control device 2100. The user interface 2008 enables the user to input information through appropriate interaction. For example, the user interface 2008 may be configured as a touchscreen, a keypad, and a control button. The user interface 2008 may transmit an input or an instruction to the controller 2120, and the controller 2120 may perform a vehicle control operation in response to the input or the instruction.

Also, the user interface 2008 may enable communication between an external device of the vehicle 2000 and the vehicle 2000 through the wireless communication device 2130. For example, the user interface 2008 may enable interaction with a mobile phone, a tablet, or other computer devices.

Further, although the example embodiment describes that the vehicle 2000 includes the engine 2006, it is provided as an example only. The vehicle 2000 may include a different type of a propulsion system. For example, the vehicle 2000 may run with electric energy, and may run with hydrogen energy or through a hybrid system with a combination thereof. Therefore, the controller 2120 may include a propulsion mechanism according to the propulsion system of the vehicle 2000 and may provide a control signal according thereto to each component of the propulsion mechanism.

Hereinafter, a configuration of the control device 2100 for digital rear view monitoring and digital video recording of the vehicle 2000 is described with reference to FIG. 13.

The control device 2100 may include the processor 2124. The processor 2124 may be a general-purpose single or multi-chip microprocessor, a dedicated microprocessor, a microcontroller, a programmable gate array, and the like. The processor may also be referred to as a central processing unit (CPU). Also, the processor 2124 may be a combination of a plurality of processors.

The control device 2100 also includes the memory 2122. The memory 2122 may be any electronic component capable of storing electronic information. The memory 2122 may include a combination of memories 2122 in addition to a unit memory.

According to various example embodiments, data and instructions 2122a for digital rear view monitoring and digital video recording of the vehicle 2000 may be stored in the memory 2122. When the processor 2124 executes the instructions 2122a, the instructions 2122a and a portion or all of the data 2122b required to perform command may be loaded to the processor 2124 (2124a and 2124b).

The control device 2100 may include a transmitter 2130a and a receiver 2130b, or a transceiver 2130c, to allow transmission and reception of signals. One or more antennas 2132a and 2132b may be electrically connected to the transmitter 2130a and the receiver 2130b, or the transceiver 2130c, and may include additional antennas.

The control device 2100 may include a digital signal processor (DSP) 2170, and may control the vehicle to quickly process a digital signal through the DSP 2170.

The control device 2100 may also include a communication interface 2180. The communication interface 2180 may include one or more ports and/or communication modules configured to connect other devices to the control device 2100. The communication interface 2180 may enable interaction between the user and the control device 2100.

Various components of the control device 2100 may be connected through one or more buses 2190, and the buses 2190 may include a power bus, a control signal bus, a state signal bus, and a database bus. The components may forward mutual information through the buses 2190 under control of the processor 2124 and may perform desired functions.

The apparatuses described herein may be implemented using hardware components, software components, and/or a combination of the hardware components and the software components. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to various example embodiments may be implemented in a form of a program instruction executable through various computer methods and recorded in computer-readable media. Here, the media may be to continuously store a computer-executable program or to temporarily store the same for execution or download. The media may be various types of record methods or storage methods in which a single piece of hardware or a plurality of pieces of hardware are combined and may be distributed over a network without being limited to a medium that is directly connected to a computer system. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

The term “module” used herein may include a unit configured as hardware, software, or firmware, and may be interchangeably used with the terms, for example, “logic,” “logic block,” “part,” “circuit,” etc. The module may be an integrally configured part, a minimum unit that performs one or more functions, or a portion thereof. For example, the module may be configured as an application-specific integrated circuit (ASIC).

According to various example embodiments, each of the components (e.g., module or program) may include a singular object or a plurality of objects. According to various example embodiments, at least one of the components or operations may be omitted. Alternatively, at least one another component or operation may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by a module, a program, or another component may be performed in a sequential, parallel, iterative, or heuristic manner. Alternatively, at least one of the operations may be performed in different sequence or omitted. Alternatively, at least one another operation may be added.

What is claimed is:

1. A video processing system connected to a front camera module and a rear camera module configured to capture a front view video and a rear view video of a vehicle, respectively, the video processing system comprising:
a digital rear mirror module configured to display the rear view video in the vehicle;
a memory configured to store the front view video and the rear view video; and
a processor connected to the digital rear mirror module and the memory, and configured to transmit the front view video and the rear view video from the front camera module and the rear camera module to the memory, and to transmit the rear view video from the rear camera module to the digital rear mirror module.

2. The video processing system of claim 1, wherein the video processing system is separately implemented with a first electronic device mounted at a predetermined location in the vehicle and including the digital rear mirror module, and a second electronic device provided separate from the first electronic device and including the memory and the processor.

3. The video processing system of claim 2, wherein the first electronic device is accommodated in a housing such that the digital rear mirror module faces the rear of the vehicle, and
the front camera module is mounted to the first electronic device to face the front of the vehicle.

4. The video processing system of claim 2, wherein the video processing system is connected to an internal camera module configured to capture an internal video of the vehicle, and
the processor is connected to the internal camera module, and configured to transmit the internal video to the memory such that the memory stores the internal video.

5. The video processing system of claim 4, wherein the first electronic device is accommodated in a housing such that the digital rear mirror module faces the rear of the vehicle, and
the internal camera module is mounted to the first electronic device to face the inside of the vehicle.

6. The video processing system of claim 2, further comprising:
an interface module connected between the front camera module and the rear camera module and the processor, and configured to transmit the front view video and the rear view video from the front camera module and the rear camera module to the processor,
wherein the second electronic device includes the interface module with the memory and the processor.

7. The video processing system of claim 1, wherein the video processing system is implemented with a single electronic device mounted at a predetermined location in the vehicle.

8. The video processing system of claim 7, wherein the electronic device is accommodated in a housing such that the digital rear mirror module faces the rear of the vehicle, and
the front camera module is mounted to the electronic device to face the front of the vehicle.

9. The video processing system of claim 7, wherein the video processing system is connected to an internal camera module configured to capture an internal video of the vehicle, and
the processor is connected to the internal camera module, and configured to transmit the internal video to the memory such that the memory stores the internal video.

10. The video processing system of claim 9, wherein the electronic device is accommodated in a housing such that the digital rear mirror module faces the rear of the vehicle, and
the internal camera module is mounted to the electronic device to face the inside of the vehicle.

11. An operating method of a video processing system connected to a front camera module and a rear camera module configured to capture a front view video and a rear view video of a vehicle, respectively, the operating method comprising:
receiving the front view video and the rear view video of the vehicle;
storing the front view video and the rear view video; and
displaying the rear view video on a digital rear mirror module.

12. The operating method of claim 11, wherein the video processing system is separately implemented with a first electronic device mounted at a predetermined location in the vehicle and including the digital rear mirror module, and a second electronic device provided separate from the first electronic device, and
the receiving the front view video and the rear view video, and the storing the front view video and the rear view video is performed by the second electronic device, and
the displaying the rear view video on the digital rear mirror module is performed by the first electronic device.

13. The operating method of claim 12, further comprising:
transmitting, by the second electronic device, the rear view video to the first electronic device.

14. The operating method of claim 12, wherein the first electronic device is accommodated in a housing such that the digital rear mirror module faces the rear of the vehicle, and
the front camera module is mounted to the first electronic device to face the front of the vehicle.

15. The operating method of claim 12, wherein the video processing system is connected to an internal camera module configured to capture an internal video of the vehicle,
the receiving the front view video and the rear view video comprises receiving the internal video with the front view video and the rear view video, and
the storing the front view video and the rear view video comprises storing the internal video with the front view video and the rear view video.

16. The operating method of claim 15, wherein the first electronic device is accommodated in a housing such that the digital rear mirror module faces the rear of the vehicle, and
the internal camera module is mounted to the first electronic device to face the inside of the vehicle.

17. The operating method of claim 11, wherein the video processing system is implemented with a single electronic device mounted at a predetermined location in the vehicle.

18. The operating method of claim 17, wherein the electronic device is accommodated in a housing such that the digital rear mirror module faces the rear of the vehicle, and
the front camera module is mounted to the electronic device to face the front of the vehicle.

19. The operating method of claim 17, wherein the video processing system is connected to an internal camera module configured to capture an internal video of the vehicle,
the receiving the front view video and the rear view video comprises receiving the internal video with the front view video and the rear view video, and
the storing the front view video and the rear view video comprises storing the internal video with the front view video and the rear view video.

20. The operating method of claim 19, wherein the electronic device is accommodated in a housing such that the digital rear mirror module faces the rear of the vehicle, and
the internal camera module is mounted to the electronic device to face the inside of the vehicle.
